(19) United States
(12) Patent Application Publication
(10) Pub. No.: US 2024/0109817 A1
(43) Pub. Date: Apr. 4, 2024

(54) A PROCESS FOR THE PRODUCTION OF A UNIFIED GRANULE OF POLYHALITE AND AN N-FERTILIZER

(71) Applicant: ICL EUROPE COOPERATIEF U.A., Amsterdam (NL)

(72) Inventors: Khalil ABU-RABEAH, Beer Sheva (IL); Amir GERBER, Sheizaf (IL)

(21) Appl. No.: 18/275,428

(22) PCT Filed: Oct. 25, 2022
(86) PCT No.: PCT/IL2022/051126

§ 371 Date: Aug. 2, 2023

Related U.S. Application Data
(60) Provisional application No. 63/273,205, filed on Oct. 29, 2021.
(60) Provisional application No. 63/283,796, filed on Nov. 29, 2021.

(51) Int. Cl. C05C 1/02

(52) U.S. Cl. CPC C05C 1/02

(57) ABSTRACT

According to some embodiments, there is provided herein a process for the production of a unified fertilizer granule of Polyhalite and an N-fertilizer, comprising adding Polyhalite to a fluidized bed reactor; adding said N-fertilizer to said reactor; and allowing the polyhalite and N-fertilizer to mix for 15-120 minutes.

### FIELD OF THE INVENTION

The present invention relates to the field of fertilizers, specifically to the production a fertilizer containing Polyhalite and an N-fertilizer.

### BACKGROUND OF THE INVENTION

To grow properly, plants need nutrients (nitrogen, potassium, calcium, zinc, magnesium, iron, manganese, etc.) which normally can be found in the soil. Sometimes fertilizers are needed to achieve a desired plant growth as these can enhance the growth of plants.

This growth of plants is met in two ways, the traditional one being additives that provide nutrients. The second mode by which some fertilizers act is to enhance the effectiveness of the soil by modifying its water retention and aeration. Fertilizers typically provide, in varying proportions, three main macronutrients:
Nitrogen (N): leaf growth;
Phosphorus (P): Development of roots, flowers, seeds, fruit;
Potassium (K): Strong stem growth, movement of water in plants, promotion of flowering and fruiting;
three secondary macronutrients: calcium (Ca), magnesium (Mg), and Sulphur (S); micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts.

The most reliable and effective way to make the availability of nutrients coincide with plant requirements is by controlling their release into the soil solution, using slow release or controlled release fertilizers.

Solid fertilizers include granules, prills, crystals and powders. A prilled fertilizer is a type of granular fertilizer that is nearly spherical made by solidifying free-falling droplets in air or a fluid medium. Most controlled-release fertilizers (CRFs) used in commercial nurseries are prilled fertilizers that have been coated with sulfur or a polymer. These products have been developed to allow a slow release of nutrients into the root zone throughout crop development.

Polyhalite is an evaporite mineral, a hydrated sulfate of potassium, calcium and magnesium with formula: K₂Ca₂Mg(SO₄)₄·2H₂O. Polyhalite is used as a fertilizer since it contains four important nutrients and is low in chloride:
48% SO₃ as sulfate
14% K₂O
6% MgO
17% CaO

Nitrogen is the essential soil mineral nutrient needed in the greatest quantity by plants and is a primary component of biological cycles. While N makes up 78% of the atmosphere, few plants (for instance, legumes) are adapted to convert or “fix” N directly from the atmosphere to satisfy their need for N. Thus, plants rely on available forms of N (ammonium; NH₄ and nitrate; NO₃) from mineralization of organic soil N or the application of fertilizer N to optimize their growth and development.

Crop production removes soil nutrients when crop outputs such as grain, straw, tubers, etc., are removed at harvest. The primary forms of N found in N fertilizers are ammonium (NH₄), nitrate (NO₃), and urea (CO(NH₂)₂) or combinations thereof. Plant availability and recovery of N from NH₄ or NH₄-forming fertilizers are reduced by N losses via leaching and runoff, denitrification, and ammonia (NH₃) volatilization. Gaseous N loss via NH₃ volatilization is a major potential pathway of loss. Therefore, NH₃ volatilization can potentially reduce a grower's economic return and have negative impacts on the environment.

Despite being both beneficial for plants, the combination of Polyhalite and an N-fertilizer is challenging since polyhalite and N-fertilizers have substantially different ductility.

### SUMMARY OF THE INVENTION

According to some embodiments, there is provided herein a process for the production of a unified fertilizer granule of Polyhalite and an N-fertilizer, comprising adding Polyhalite to a fluidized bed reactor; adding said N-fertilizer to said reactor; and allowing the polyhalite and N-fertilizer to mix for 15-120 minutes; and wherein said N-fertilizer comprises at least one fertilizer selected from the group including: Urea, Ammonium Sulphate, Ammonium Nitrate, Calcium Ammonium Nitrate (CAN), Magnesium Ammonium Nitrate (MAN).

According to some embodiments, wherein said unified fertilizer granule comprises a uniformity index of at least 50, preferably at least 55.

According to some embodiments, the N-fertilizer may preferably be Urea.

According to some embodiments, the N-fertilizer may preferably be Calcium Ammonium Nitrate (CAN).

According to some embodiments, the process may further include the step of adding Carbonate salts, sulphate salts Potassium salts, magnesium salts, micronutrients, and/or bentonite, before mixing the polyhalite and the N-fertilizer.

According to some embodiments, there is provided herein a process for the production of a unified fertilizer granule of Polyhalite and an N-fertilizer, comprising adding Polyhalite to and said N-fertilizer to a compactor; and allowing the polyhalite and N-fertilizer to be compacted for 15-120 minutes.

According to some embodiments, there is provided herein a fertilizer granule including polyhalite and at least one compound selected from the group including ammonium nitrate (AN), calcium ammonium nitrate (CAN), and magnesium ammonium nitrate (MAN), wherein the ratio between Polyhalite and said at least one compound is between 30:70 to 70:30, respectively.

According to some embodiments, the Polyhalite and calcium ammonium nitrate, may be in a ratio of 30:70 respectively.

According to some embodiments, the granule may further include an additive selected from the group including Carbonate salts, sulphate salts Potassium salts, magnesium salts, micronutrients, and/or bentonite.

According to some embodiments, there is provided herein a process for the production of a unified fertilizer granule of Polyhalite and an N-fertilizer, comprising adding Polyhalite to a fluidized bed reactor; adding said N-fertilizer to said reactor; and allowing the polyhalite and N-fertilizer to mix for 15-120 minutes.

According to some embodiments, the N-fertilizer may comprise at least one fertilizer selected from the group including: Urea, Ammonium Sulphate, Ammonium Nitrate, Calcium Ammonium Nitrate (CAN), Magnesium Ammonium Nitrate (MAN).

According to some embodiments, the N-fertilizer may preferably be urea.

### DETAILED DESCRIPTION OF THE INVENTION

According to some demonstrative embodiments, there is provided herein a process for producing a unified granule of Polyhalite and an N-Fertilizer, wherein said process includes subjecting the Polyhalite and N-fertilizer to a chemical reaction taking place in a mixing machine.

Wherein the term unified or uniformed refers to having a uniformity index of at least 50, preferably at least 55.

According to some embodiments, the N-fertilizer may be at least one fertilizer selected from the group including: Urea, Ammonium Sulphate, Ammonium Nitrate, Calcium Ammonium Nitrate (CAN), Magnesium Ammonium Nitrate (MAN).

According to some preferred embodiments, the N-fertilizer may be Urea.

According to some demonstrative embodiments, the mixing machine may be selected from the group including a fluidized bed reactor, a pan reactor, a drum reactor and/or any suitable compactor.

According to some preferred embodiments, the unique combination of Polyhalite and urea may be especially advantageous when the mixing machine is a fluidized bed reactor due to the enablement of a uniform particle mixing in the reactor.

According to some embodiments, the complete mixing allowed by the reactor creates a uniform granule that can often be hard to achieve in other reactor designs. The elimination of radial and axial concentration gradients also allows for better fluid-solid contact, which is essential for reaction efficiency and quality, especially in the case of Polyhalite and urea, wherein Polyhalite has very low solubility.

According to some embodiments, the use of a fluidized bed in the process of the present invention allows for uniform temperature gradients.

According to some embodiments, in contrast to other chemical reactions that may require the addition or removal of heat, local hot or cold spots within the reaction bed, often pose a problem in packed beds. These are avoided in a fluidized situation such as in the present invention.

According to some embodiments, the granule of the present invention may further include one or more additional fertilizers, for example, selected from the group including any material of natural or synthetic origin that is applied to soils or to plant tissues to supply one or more plant nutrients essential to the growth of plants, including, for example, Single nutrient (“straight”) fertilizers such as Ammonium nitrate, Urea, calcium ammonium nitrate, superphosphate, e.g., “Single superphosphate” (SSP), phosphogypsum, Triple superphosphate (TSP) or a mixture thereof; Multinutrient fertilizers such as Binary (NP, NK, PK) fertilizers, e.g., monoammonium phosphate (MAP) and/or diammonium phosphate (DAP), NPK fertilizers which are three-component fertilizers providing nitrogen, phosphorus, and potassium; fertilizers which include one or more of the main micronutrients sources of iron, manganese, boron, molybdenum, zinc, and copper and the like; Compound fertilizers, e.g., which contain N, P, and K; Organic fertilizers such as peat, animal wastes, plant wastes from agriculture, and sewage sludge; and/or Other elements such as calcium, magnesium, and sulfur.

According to some embodiments, the process of the present invention may take place in a continuous state. In addition, according to some embodiments, the fluidized bed reactor of the present invention may allow to introduce new reactants into the reaction. According to some embodiments, the process of the invention may include adding one or more phosphate fertilizers mixing the Polyhalite and N-fertilizer, for example, for providing a plant with N, P, K, S, K, Mg, Ca, micronutrients.

According to some embodiments, the process may include adding additional substances, for example, for absorbing water, such as lignite and/or substances to reduce ammonia emission like brown coal, thiosulphate salts, zinc salts; a binder like starch; silicate, geopolymers or lignite; one or more micronutrients like micronutrients: copper (Cu), iron (Fe), manganese (Mn), molybdenum (Mo), zinc (Zn), boron (B), and of occasional significance there are silicon (Si), cobalt (Co), and vanadium (V).

According to some embodiments, the process of the present invention may include adding herbicides, b acteri oci di c and/or bacteriostatic substances.

According to some embodiments, the process of the present invention may include one or more binders selected from the group including bentonite, lignosulfonates, molasses, hydrated lime, bitumen, Portland cement, clay, acids (nitric, hydrochloric, phosphoric, sulphuric), cellulose gum, sucrose, water, water glass, cements, Starch, activated starch, whether alone or in combination with potassium silicate; meta kaolin; potassium silicate; sodium silicate or a combination thereof.

According to some embodiments the process of the present invention may further include the step of coating.

According to some embodiments, the process of the present invention may include additional materials like kieserite, langbeinite, kainite, potash and/or SOP which may be added in the same proportions as Polyhalite.

According to some embodiments, the process of the present invention may include feeding Polyhalite together with solid urea (seed material) in the fluidized-bed granulator.

According to some embodiments, there is provided herein a process for the production of a unified fertilizer granule of Polyhalite and an N-fertilizer, comprising adding Polyhalite and said N-fertilizer to a compactor; and allowing the polyhalite and N-fertilizer to be compacted for 15-120 minutes.

According to some embodiments, the combination of Polyhalite and an N-fertilizer is a complicated process since polyhalite and the N-fertilizer have substantially different ductility. As such, it is difficult to cause the adherence of Polyhalite and an N-fertilizer, especially, an N-fertilizer from the group including: Urea, Ammonium Sulphate, Ammonium Nitrate, Calcium Ammonium Nitrate (CAN), Magnesium Ammonium Nitrate (MAN).

According to some embodiments, the process of the present invention may enable overcoming the challenge of adhering Polyhalite and an N-fertilizer in a single granule, for example, by using a fluidized bed to allow uniform temperature gradients.

According to some embodiments, the process may further enhance the adherence between Polyhalite and an N-fertilizer in a single granule by using one or more material facilitating the adherence such as limestone or a binder.

Adhering the polyhalite and the N-fertilizer may also result in a non-uniform granule, i.e., containing aggregations of Polyhalite and/or N-fertilizer in certain areas of the granule, and as such, for example, may cause a non-even dispersion or release of the fertilizers from the granule.

According to some embodiments, the unique process of the present invention allows for the creation of a unified granule, including, for example, a uniformity index of 50 or above, preferably 55 or above.

According to some embodiments, the uniformity index of at least 50 is achieved because the process of the present invention specifically uses a fluidized bed reactor.

According to some demonstrative embodiments, there is provided herein a fertilizer granule including polyhalite and ammonium nitrate (AN), in a ratio of between 30:70 to 70:30, respectively, preferably 50:50, most preferably 30:70.

According to some demonstrative embodiments, there is provided herein a fertilizer granule including polyhalite and calcium ammonium nitrate

(CAN), in a ratio of between 30:70 to 70:30, respectively, preferably 50:50, most preferably 30:70.

According to some demonstrative embodiments, there is provided herein a fertilizer granule including polyhalite and ammonium nitrate

(CAN), in a ratio of between 30:70 to 70:30, respectively, preferably 50:50, most preferably 30:70.

According to some demonstrative embodiments, there is provided herein a fertilizer granule including polyhalite and magnesium ammonium nitrate (MAN), in a ratio of between 30:70 to 70:30, respectively.

According to some demonstrative embodiments, there is provided herein a fertilizer granule including a mixture of Polyhalite with AN, CAN and/or MAN.

The kinetic solubility of N fertilizers is high. According to some embodiments, the granule of the present invention may have a controlled solubility, either by coating a Polyhalite granule with an N fertilizer or via formation of a Polyhalite granule containing an N fertilizer in a slow soluble matrix.

According to some embodiments, there is provided herein a process for the granulation of Polyhalite with ammonium nitrate (AN), CAN, and MAN comprising:
mixing a feed of Polyhalite with a feed of one or more of AN, CAN and/or MAN as solid or as a melt, to yield a mixture;
Carbonate salts, sulphate salts Potassium salts, magnesium salts, micronutrients, and/or bentonite may be added to the mixture;
Granulating the mixture in a suitable granulator selected from the group including, plunger granulator, drum granulator, pan granulator and/or high shear granulator, to yield particle masses;
Screening the particle masses in a screener to yield different fractions in three different sizes: Oversized particles which undergo a crushing process and are returned to the granulator as recycle, desired size granular particles which are transferred to coating and fine particle which are transferred back to the granulator.

According to some embodiments, the granule of the present invention may also include one or more micronutrients, including, for example, copper (Cu), iron (Fe), manganese (Mn), molybdenum (Mo), zinc (Zn), boron (B), and of occasional significance there are silicon (Si), cobalt (Co), and vanadium (V) plus rare mineral catalysts.

### EXAMPLES

### Example 1

The experiments were designed to develop a complex, unified fertilizer based on polyhalite and an N-fertilizer
1. Polyhalite+Ammonium nitrate-43% Polyhalite+57% AN
2. Polyhalite+urea−50% Polyhalite+50% urea

Procedure

Laboratory Experiments

Polyhalite grinded at least 60%<0.6 mm, and mixed with AN solution or AN melt. Table 1 demonstrates the CRH at various proportion Poly/AN

### Experiments Set 1—Laboratory Scale

TABLE 1

| | | | | |
|---|---|---|---|---|
| Proportion | 80/20 | 75/25 | 65/35 | 57/43 |
| POLY/AN in | | | | |
| % | | | | |
| CRH % | 50-55 | 50-55 | 50-55 | 50-55 |
| Solidification | 3.5 | 3.5 | 3.5 | 3.5 |
| time | | | | |
| In minutes | | | | |

### Experiments Set 2—Laboratory Scale

In this set we try to enlarge solidification time by adding AN as melt comparing to adding in 92% solution and with and without adding limestone.

In some of the experiments the polyhalite—an melt poured on

TABLE 2

| | | | | Solid- | |
|---|---|---|---|---|---|
| | | | | ification | |
| | | | AN | time | |
| Raw materials in % | | | added | in | |
| AN | POLY | Limestone | as | minutes | Remarks |
| 50 | 50 | 0 | melt | 4.5 | no drum used |
| 50 | 45 | 5 | melt | 4.5 | no drum used |
| 50 | 40 | 10 | melt | 3.5 | no drum used |
| 50 | 45 | 5 | solution | >5.5 | no drum used |
| 50 | 45 | 5 | solution | >5.5 | Drum with hot air |
| 50 | 45 | 5 | solution | >5.5 | Drum with ambient air |
| 50 | 45 | 5 | Solution + | | Drum with ambient air |
| | | | 30% prill | | Dififcult to stir |
| | | | prills | | |
| 50 | 45 | 5 | solution | >5.5 | Drum with ambient air |

### Experiments Set—Pilot Scale

Procedure

Polyhalite and AN solution are fed into screw type feeder and discharged to rotary drum granulator, 41 cm diameter and 81 cm in length. From the rotary drum the material is discharged by gravity to a rotary cooler 31 cm diameter and 203 cm in length. The material is cooled with air flow

The cooled material from the cooler is transferred to a second cooler 25 cm in diameter and 152 cm in length for cooling with air flow.

The material is then fed to a screening system. The over size >4 mesh+4.75 mm−2.36 mm transfer to hammer mill and return to screening. The undersized <8 mesh recycle to the granulator. The product 4-8 mesh 4.75-2.35 mm collected to further tests.

TABLE 3

| | |
|---|---|
| Production rate | 21.5 kg/hr |
| AN solution temperature | 119 degree |
| AN solution concentration | 88% |
| Polysulphte feed to granulator | 11 kg/hr |
| AN solution feed to granulator | 11.7 kg/hr |
| Recycle to product ratio | 4.7 |
| Inlet temperature to dryer | 190 degree |
| Material discharge temperature | 57 |
| Product temperature | 29 degree |

Product Properties
Samples collection through poly-AN production
Uniformity index-50

Chemical composition
Total-N-13.7%
Total S-10.9%
K2O-7.6%
CaO-10.3
MgO-4.2%
H20-0.6%

CRH with limestone 65-70%

### Example 2

### Introduction

The main objective of this experiment is to check the technical feasibility to obtain parameter for scale up of producing fertilizer containing polyhalite and urea in continuous pilot scale system.

Procedure

polyhalite feed to screw type solid feeder, and discharge gravity to drum granulator. Urea melt at or solution and % was prepared at temperature. The urea and polyhalite and sprayed in the drum granulator, 41 cm in diameter and 81 cm length. A 6.5 cm dam located 20 cm from the discharge point. The granulator equipped with mechanical scraper to avoid buildup of material on the granulator wall.

The moist granules from the granulator discharge gravimetry to cooler, 31 cm diameter and 203 cm in length. The granules in the cooler dried with air flow. The rotational velocity of the dryer 8 rpm. The material from the dryer discharge to rotary drum cooler 25 cm in diameter and 152 cm in length cooling was achieved by air flow.

The material from the dryer transfer to screening system.

The oversized >5.16 mm mesh were transferred to a hammer mill and recycled to screening. The undersized <2.36 mm were recycled back to the granulator.

The product collected and was sent to further testing.

Every 30 minutes a sample was taken.

### Example 3

To the pilot plant 11.3 kg/hr of polyhalite and 12.1 kg/hr of urea solution was fed. The temperature of urea solution was 130 C degrees and concentration 92.9%

The bed temperature in the granulator was 36 degrees
Rotation velocity of the granulator was 22 rpm
The recycle to product ratio-5.1.
The inlet air flow to the dryer 131 kg/hr and temperature 199 C degree.
The material was discharged at 54 C degrees and after cooler 36 degree.
The dust was collected in cyclone
Product rate in kg/hr 22.6

Product Properties

Chemical Composition

Total N-24.6%
Total-S-8%
K2O-6.1%
CaO- 7.7%
MgO-3%
H2O-0.9%

Physical Properties

Size Analysis

| mm | % |
|---|---|
| 4.75 | o |
| 4 | 2 |
| 3.35 | 19.9 |
| 2.8 | 47.2 |
| 2.36 | 83.5 |
| 2.0 | 97.2 |
| 1.7 | 99.1 |

Uniformity index-55
Average Crushing strength granules 0.93 kg/granule
Average Crushing strength granules after drying in oven 1 hour at 80 C—1.49 kg/granule
CRH 60-65%

### Example 4

As in example 3

To the pilot plant 11.4 kg/hr of polyhalite and 12.3 kg/hr of urea solution were fed. The temperature of the urea solution was 128 C degrees and concentration 93.2% Rotation velocity of granulator 22 rpm

The bed temperature in the granulator 36 C degree

The recycle to product ratio-2.4.

The inlet air flow to the dryer 76 kg/hr and temperature 163 C degree.

The material discharge at 48 C degree. And after cooler 30 C degree.

Product Properties

Chemical Composition
Total N—24.7%
Total-S—8.6%
K2O—6.1%
CaO—7.7%
MgO—3.2%
H2O—0.5%

Physical Properties

Size Analysis

| mm | % |
|---|---|
| 4.75 | o |
| 4 | 1.6 |
| 3.35 | 23.5 |
| 2.8 | 54.1 |
| 2.36 | 82.9 |
| 2.0 | 97.2 |
| 1.7 | 99.1 |

Uniformity Index-57
Average Crushing strength granules 1.26 kg/granule
Average Crushing strength granules after drying in oven 1 hour at 80 C—1.41 kg/granule
CRH 60-65%

### Example 5

As in example 4, but the oversize screen was changed to 5.16 screen

Product Properties

Chemical Composition
Total N—24.8%
Total-S—8.6%
K2O—5.8%
CaO—8.3%
MgO—3.1%
H2O—0.6%

Physical Properties

Size Analysis

| mm | % |
|---|---|
| 4.75 | 1.7 |
| 4 | 17.2 |
| 3.35 | 35.4 |
| 2.8 | 68.1 |
| 2.36 | 98.1 |
| 2.0 | 99.7 |
| 1.7 | — |

Uniformity index-55
Average Crushing strength granules 0.88 kg/granule
Average Crushing strength granules after drying in oven 1 hour at 80 C—1.71 kg/granule
CRH 60-65%
Abrasion 0.53%

While this invention has been described in terms of some specific examples, many modifications and variations are possible. It is therefore understood that within the scope of the appended claims, the invention may be realized otherwise than as specifically described.

1. A process for the production of a unified fertilizer granule of Polyhalite and an N-fertilizer, comprising
Adding Polyhalite to a fluidized bed reactor;
Adding said N-fertilizer to said reactor; and
Allowing the polyhalite and N-fertilizer to mix for 15-120 minutes; and
wherein said N-fertilizer comprises at least one fertilizer selected from the group including: Urea, Ammonium Sulphate, Ammonium Nitrate, Calcium Ammonium Nitrate (CAN), Magnesium Ammonium Nitrate (MAN).

2. The process of claim 1, wherein said N-fertilizer is Urea.

3. The process of claim 1, wherein said N-fertilizer is Calcium Ammonium Nitrate (CAN).

4. The process of claim 1, further comprising the step of adding Carbonate salts, sulphate salts Potassium salts, magnesium salts, micronutrients, and/or bentonite.

5. A process for the production of a unified fertilizer granule of Polyhalite and an N-fertilizer, comprising
Adding Polyhalite to and said N-fertilizer to a compactor; and
Allowing the polyhalite and N-fertilizer to be compacted for 15-120 minutes.

6. A fertilizer granule including polyhalite and at least one compound selected from the group including ammonium nitrate (AN), calcium ammonium nitrate (CAN), and magnesium ammonium nitrate (MAN), wherein the ratio between Polyhalite and said at least one compound is between 30:70 to 70:30, respectively.

7. The granule of claim 1, comprising Polyhalite and calcium ammonium nitrate, in a ratio of between 30:70 to 70:30, respectively.

8. The granule of claim 2, wherein said ratio is 30:70, respectively.

9. The granule of claim 1, further comprising an additive selected from the group including Carbonate salts, sulphate salts Potassium salts, magnesium salts, micronutrients, and/or bentonite.
